(19) United States
(12) Patent Application Publication
(10) Pub. No.: US 2013/0020307 A1
(43) Pub. Date: Jan. 24, 2013

(54) WARMING DEVICE, DISH FOR A WARMING DEVICE AND RELATED METHODS

(71) Applicants: Jon E. Ashton, Eagle, ID (US); Rod Brown, Star, ID (US); Darin Bishop, Meridian, ID (US); R. Orville Thompson, Eagle, ID (US)

(72) Inventors: Jon E. Ashton, Eagle, ID (US); Rod Brown, Star, ID (US); Darin Bishop, Meridian, ID (US); R. Orville Thompson, Eagle, ID (US)

(73) Assignee: SCENTSY, INC., Meridian, ID (US)

(21) Appl. No.: 13/554,803

(22) Filed: Jul. 20, 2012

Related U.S. Application Data
(63) Continuation-in-part of application No. PCT/US2012/035859, filed on Apr. 30, 2012.
(60) Provisional application No. 61/510,925, filed on Jul. 22, 2011.

(51) Int. Cl. H05B 6/00

(52) U.S. Cl. 219/387

(57) ABSTRACT

A warming dish for use with a flameless warming device includes a main body and a heat spreader. The main body includes a base and side walls extending from the base portion to define a volume for containing liquid. The base is sized and configured to rest upon a base of a flameless warming device. The heat spreader may be in contact with the base such that heat generated within a base of a flameless warming device is transmitted by the heat spreader to the base of the main body of the dish. Flameless warming devices include such warming dishes. Methods of serving melted chocolate before bloom is observable on the chocolate utilize such warming devices in combination with opaque microwavable packages. Methods of manufacturing such warming dishes include forming the main body portion and providing the heat spreader in physical contact with the main body portion.

### PRIORITY CLAIM

This application is a continuation-in-part application of International Patent Application PCT/US2012/035859, filed Apr. 30, 2012, which claims the benefit of the filing date of U.S. Provisional Patent Application Ser. Number 61/510,925, filed Jul. 22, 2011, for “DISH FOR WARMING DEVICE,” the disclosures of which applications are hereby incorporated herein in their entireties by this reference.

### TECHNICAL FIELD

Embodiments of the present disclosure relate generally to dishes for containing food items, and, more particularly, to dishes that may sit atop a warming device for warming food within the dishes, and to assemblies that include such a warming device and dish.

### BACKGROUND

Candle warmers have become popular in recent years. A candle warmer is a warming device (e.g., electric plate or the like) that melts a candle or scented wax to release its scent. Candle warmers provide many of the benefits of scented candles, but without the need for an open flame. Candle warmers are used with jar candles or candles in cups or other containers that can hold the melted wax. Use of a candle warmer avoids the open flame and soot that can result from the actual burning of scented candles. When a scented candle (having a wick) is used with a candle warmer, the later-cooled and solidified candle can also be burned in the normal manner. On the other hand, so-called “wickless” candles have also been developed for use with candle warmers. A wickless candle is a quantity of scented candle wax in a container (e.g., a glass jar or other package) with no wick. These are designed to be placed on a candle warmer to release the scent, but unlike true candles, cannot be burned in the normal manner otherwise.

There are a variety of types of candle warmers. Some involve a simple electrically heated plate, upon which a jar candle (wickless or otherwise) is placed. On the other hand, decorative candle warmers that use an electric light bulb as a heat source have also been developed. Electric bulb-type candle warmers provide heat for melting the wax of the scented candle, and because of the light bulb can also provide a desired candle-type ambiance, without the need for a flame. Some candle warmers of this type provide an open-top decorative base, made of ceramic or other decorative material, with a container or dish specially designed to sit atop the base and hold the scented wax. The electric light bulb is contained within the base, and sits just below the dish, thus heating it, while some quantity of light may shine through holes or openings in the side of the base, for the desired ambiance.

This sort of configuration is desirable in part because of the way that candle warmers and related supplies are sold. Candle warmers and related products are often marketed specifically through multi-level marketing organizations, and are frequently sold via parties or group demonstrations in private homes. These candle warmer parties are social events that can become somewhat elaborate, involving food, music, and other elements along with the candles and warming devices that provide the ambiance for the event.

### SUMMARY

It has been recognized that it would be advantageous to develop other uses for flameless candle warmers.

It has also been recognized that private marketing events for candle warmers and related products can benefit from the introduction of food-related uses for candle warmer products.

In some embodiments, the present disclosure includes a warming dish for use with a flameless warming device. The warming dish includes a main body and a heat spreader. The main body includes a base portion and side walls integral with and upwardly extending from the base portion. The base portion is sized and configured to rest upon a base of a flameless warming device, and the side walls and the base portion together define an interior volume of the warming dish for containing a volume of liquid. The main body of the dish comprises a material that exhibits a relatively low thermal conductivity, and the heat spreader comprises a material that exhibits a relatively high thermal conductivity. The heat spreader is in direct physical contact with the base portion of the main body such that thermal energy generated by a base of a flameless warming device is transmitted by the heat spreader to the base portion of the main body to regulate and moderate a temperature of the base portion during use.

In additional embodiments, the present disclosure includes a flameless warming device that comprises a decorative base including a heater for generating thermal energy; and a warming dish configured to rest atop the decorative base. The heater comprises at least one of an incandescent light bulb and a heating element. The warming dish is removable from the decorative base, and includes a main body and a heat spreader. The main body includes a base portion and side walls integral with and upwardly extending from the base portion. The base portion is sized and configured to rest upon a base of a flameless warming device, and the side walls and the base portion together define an interior volume of the warming dish for containing a volume of liquid. The main body of the dish comprises a material that exhibits a relatively low thermal conductivity, and the heat spreader comprises a material that exhibits a relatively high thermal conductivity. The heat spreader is in direct physical contact with the base portion of the main body such that thermal energy generated by a base of a flameless warming device is transmitted by the heat spreader to the base portion of the main body to regulate and moderate a temperature of the base portion during use.

In further embodiments, the present disclosure includes a method of serving melted chocolate. For example, the method includes providing a warming dish, heating a substantially enclosed opaque container carrying chocolate therein (e.g., in a microwave oven) until the chocolate is melted, and pouring the melted chocolate from a spout integrally formed on the opaque container and into the warming dish. The warming dish includes a main body and a heat spreader. The main body includes a base portion and side walls integral with and upwardly extending from the base portion. The base portion is sized and configured to rest upon a base of a flameless warming device, and the side walls and the base portion together define an interior volume of the warming dish for containing a volume of liquid. The main body of the dish comprises a material that exhibits a relatively low thermal conductivity. The heat spreader comprises a material that exhibits a relatively high thermal conductivity. The heat spreader is in direct physical contact with the base portion of the main body such that thermal energy generated by a base of a flameless warming device is transmitted by the heat spreader to the base portion of the main body to regulate and moderate a temperature of the base portion during use.

In yet further embodiments, the present disclosure includes methods of manufacturing such warming dishes and flameless warming devices. For example, a main body of a warming dish may be formed that includes a base portion and side walls integral with and upwardly extending from the base portion. The base portion may be sized and configured to rest upon a base of a flameless warming device. The side walls and the base portion together may define an interior volume of the warming dish for containing a volume of liquid. The main body may comprise a material selected to exhibit a relatively low thermal conductivity. A heat spreader comprising a material exhibiting a relatively high thermal conductivity may be provided in direct physical contact with the base portion of the main body such that thermal energy generated by a base of a flameless warming device is transmitted by the heat spreader to the base portion of the main body to regulate and moderate a temperature of the base portion during use.

### BRIEF DESCRIPTION OF THE DRAWINGS

Additional features and advantages of the disclosure will be apparent from the detailed description which follows, taken in conjunction with the accompanying drawings, which together illustrate, by way of example, features of the disclosure, and wherein:

FIG. 1 is a perspective view of flameless warming device that includes a warming dish resting upon a decorative base configured to heat the warming dish and food or other matter contained therein in accordance with embodiments of the present disclosure;

FIGS. 2 through 11 illustrate embodiments of a heating assembly configured for use with the warming device of FIG. 1;

FIG. 2 is a perspective view of a lighting module that may be used with the warming device of FIG. 1;

FIG. 3 illustrates a cross-sectional view of the lighting module of FIG. 2;

FIG. 4 illustrates a perspective view of an assembly of electrical light sources that may be used with the lighting module of FIG. 2;

FIG. 5 illustrates a plan view from below the assembly of electrical light sources of FIG. 4 depicting circuitry that may be used with the assembly of electrical light sources;

FIG. 6 illustrates a circuit diagram of a circuit that may be used with the assembly of electrical light sources of FIG. 4;

FIG. 7 illustrates a perspective view of a heating module that may be used with the warming device of FIG. 1;

FIG. 8 illustrates a cross-sectional view of the heating module shown in FIG. 7;

FIG. 9 illustrates a perspective view of a heating assembly including the lighting module of FIGS. 2 through 4 with the heating module of FIGS. 7 and 8;

FIG. 10 illustrates a cross-sectional view of the heating assembly of FIG. 9.

FIG. 11 illustrates a simplified cross-sectional view of the warming device of FIG. 1 including the heating assembly of FIGS. 9 and 10;

FIGS. 12 through 18 illustrate embodiments of a warming dish for use with the warming device of FIGS. 1 and 11;

FIG. 12 is a top view of the warmer dish of the warming device of FIG. 1;

FIG. 13 is a bottom view of the warming dish of FIG. 12;

FIG. 14 is a side view of the warming dish of FIGS. 12 and 13;

FIG. 15 is a side cross-sectional view of warming dish having a removable heat spreader;

FIG. 16 is a side cross-sectional view of a heat spreader with rounded edges;

FIG. 17 is a perspective view of a warming dish having a divider;

FIG. 18 is a perspective view of another embodiment of a warming dish for use with a warming device in accordance with the present disclosure, similar to the warming dishes shown in FIG. 1 and FIGS. 12 through 14.

FIG. 19 is a cross-sectional view of a warming device having a second warming dish; and

FIG. 20 is a perspective view of an opaque, microwavable package for use with a warming device.

### DETAILED DESCRIPTION

The illustrations presented herein are not meant to be actual views of any particular warmer dish, warmer device, or components thereof, but are merely idealized representations that are employed to describe certain disclosed embodiments. Thus, the drawings are not necessarily to scale and relative dimensions may have been exaggerated for the sake of clarity or simplicity. Additionally, elements common between figures may retain the same or similar numerical designation.

Electric flameless candle warmers typically include a decorative base having an open top, and an incandescent light bulb (e.g., a 25 watt light bulb) contained within the base. The incandescent light bulb is used both to generate light and to generate heat. The light generated by the incandescent light bulb is permeated out through apertures formed in the base or through at least partially transparent sidewalls provided on the base to provide a desirable ambiance. The heat generated by the incandescent light bulb is used to warm scented wax provided in a warming dish configured to rest upon and over the open top of the decorative base. Such warming bases are referred to herein as “incandescent bulb warming bases.”

In additional embodiments, one or more light-emitting diodes (LED's) may be provided within the decorative base and used to generate light, and a separate warming device, such as a resistive heating element, also may be provided within the decorative base and used to generate heat for warming the warming dish. Such warming bases are disclosed in, for example, U.S. Patent Application Publication No. US 2012/0024837 A1, which published Feb. 2, 2012 in the name of Thompson, and U.S. patent application Ser. No. 13/160,842, which was filed Jun. 15, 2011 in the name of Juarez, each of which is incorporated herein in its entirety by this reference. Such warming devices are referred to herein as “LED warming bases,” although it is to be appreciated that in LED warming bases, the heat is primarily supplied by the resistive heating element.

An electrical cord may be provided for connecting the warming device to an electrical power source, and a switch may be provided to allow a user to turn the warming device on and off. The decorative base may be made of a variety of materials and have a variety of shapes and configurations. For example, such devices are often generally rectangular in shape and made of ceramic. On the other hand, incandescent bulb-type candle warmers can have many different shapes, such as circular, and can be made of a variety of different materials in addition to ceramic.

The open top of the decorative base of a flameless candle warmer may be configured with features that are complementary to features of a warming dish configured to rest thereon, in which scented wax can be melted by the heat of the incandescent light bulb or other heating element contained within the decorative base. For example, the warming dish may include a ridge or recess sized and configured to mate with a complementary recess or ridge, respectively, at an upper end of the base, thereby holding the warming dish in a relatively stable position in close proximity to the incandescent bulb or other heating element.

In accordance with embodiments of the present disclosure, assemblies that include a warming device and a warming dish configured to rest upon the warming device, like those previously known for use as flameless candle warmers, may be used to heat food products, such as chocolate, cheese and other sauces, etc. Thus, in some embodiments, a flameless candle warmer may be used for fondue-type foods.

In some embodiments, the assemblies may be configured to heat food within the warming dish to temperatures that are more desirable for foods. Previously known candle warmers typically warm scented wax in the warming dish to a temperature in a range extending from about 73.9° C. (165° F.) to about 93.3° C. (200° F.). In accordance with embodiments of the present disclosure, the assemblies may be configured to heat food within the warming dish to temperatures of about 80° C. (175° F.) or less, as discussed in further detail below.

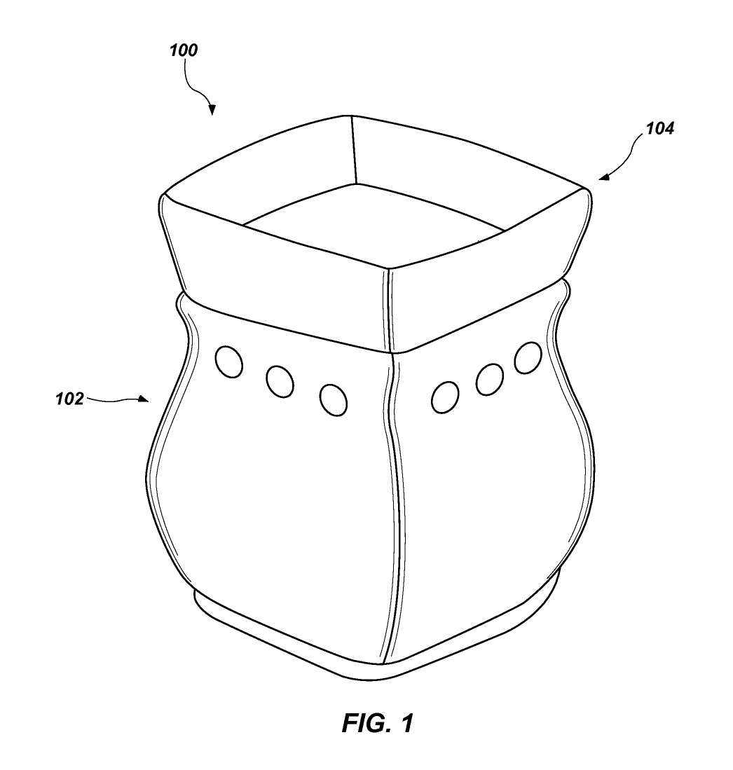

FIG. 1 is a perspective view of a flameless warming device 100 in accordance with embodiments of the present disclosure, which includes a decorative base 102 and a warming dish 104 configured to rest upon the decorative base 102. In some embodiments, the decorative base 102 may comprise an incandescent warming base as described above in relation to decorative bases for flameless candle warming devices. Thus, in such embodiments, the decorative base 102 may include an Edison-type light bulb socket configured to receive an incandescent light bulb therein, which may be used both to generate light and to generate heat for warming the warming dish 104 and any food contained therein.

In additional embodiments, the decorative base 102 may comprise an LED warming base, such as those disclosed in the aforementioned U.S. Patent Application Publication No. US 2012/0024837 A1 and U.S. patent application Ser. No. 13/160,842, which have been previously incorporated by reference. Thus, in such embodiments, the decorative base 102 may include one or more light-emitting diodes (LEDs) for generating light, and a separate warming device, such as a resistive heating element, for heating the warming dish and any food contained therein.

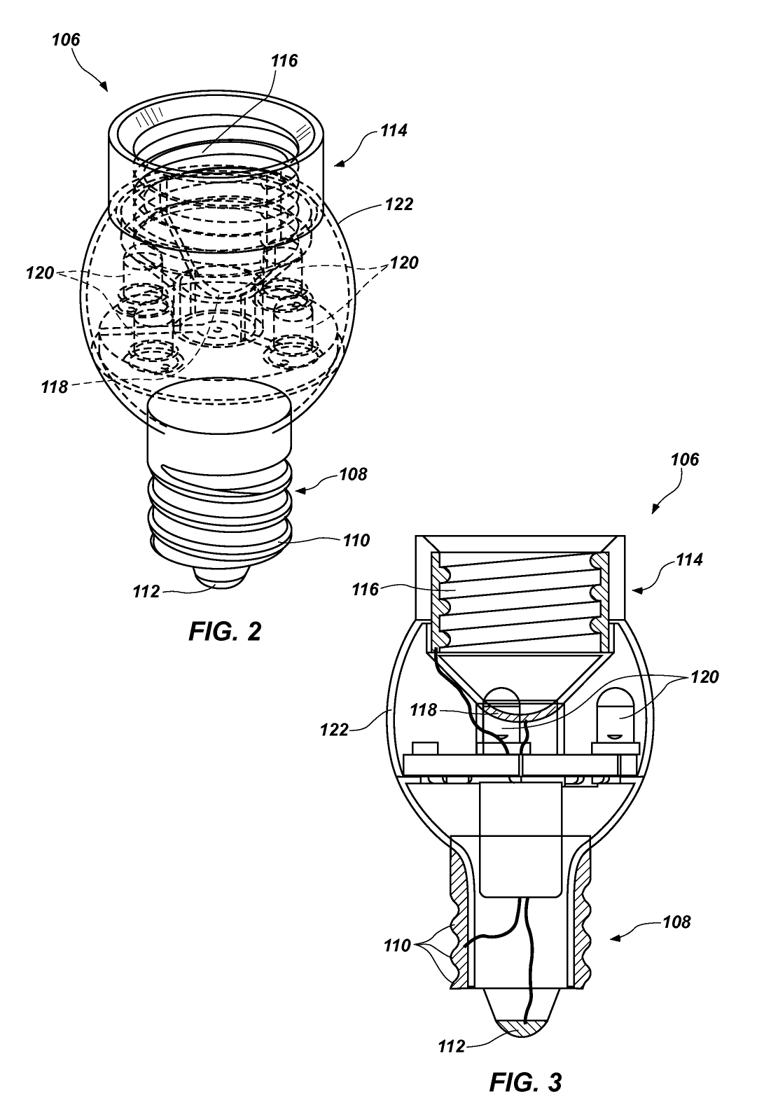

FIGS. 2 through 11 illustrate embodiments of a heating assembly configured to heat the warming dish 104 from inside the decorative base 102.

Referring to FIGS. 2 and 3, a perspective view and a cross-sectional view of a lighting module 106 that may be used with a heating assembly are shown, respectively. The lighting module 106 comprises a lower electrical connector 108. The lower electrical connector 108 may be disposed at a lower portion of the lighting module 106. Thus, the lighting module 106 may be configured for physical and electrical engagement with an electrical connector of a base structure on the decorative base 102. The lower electrical connector 108 may comprise at least one helically extending protrusion 110 configured to threadedly engage and electrically communicate with a helically extending recess in the electrical connector of the base structure on the decorative base 102. The lower electrical connector 108 may also comprise at least one contact 112 configured to electrically communicate with a contact of the electrical connector of the base structure to form a closed electrical path. At least a portion of the lower electrical connector 108 may comprise an electrically conductive material and may be configured to receive electrical power from an electrical power source.

The lighting module 106 may further comprise an upper electrical connector 114. The upper electrical connector 114 may be disposed at an upper portion of the lighting module 106. Thus, the lighting module 106 may be configured to receive an electrical connector from above the lighting module 106. The upper electrical connector 114 may comprise at least one helically extending recess 116 configured to threadedly engage and electrically communicate with a male threaded electrical connector and at least one contact 118 configured to communicate with a contact of the male threaded electrical connector to form a closed electrical path. At least a portion of the upper electrical connector 114 may comprise an electrically conductive material and may be in electrical communication with the lower electrical connector 108. For example, a pass-through electrical connection may provide electrical communication between the lower electrical connector 108 and the upper electrical connector 114. Thus, a single power source may provide electrical power to both the lower electrical connector 108 and the upper electrical connector 114.

The lighting module 106 may comprise at least one electrical light source 120 interposed between the lower electrical connector 108 and the upper electrical connector 114. Thus, the lower electrical connector 108 may be disposed on a first, lower side of the electrical light source 120, and the upper electrical connector 114 may be disposed on another, upper side of the electrical light source 120 opposing the first, lower side on which the lower electrical connector 108 is disposed. As shown in FIGS. 2 and 3, a plurality of electrical light sources 120 may be disposed in an array between the lower electrical connector 108 and the upper electrical connector 114. For example, four electrical light sources 120 may be distributed in a substantially uniformly spaced array around a periphery of the lighting module 106. The electrical light sources 120 may be in electrical communication with the lower electrical connector 108. For example, a pass-through electrical connection may provide electrical communication between the lower electrical connector 108 and the electrical light sources 120. Thus, a single power source may provide electrical power to the lower electrical connector 108, the upper electrical connector 114, and the electrical light sources 120.

The lighting module 106 may include a cover member 122. The cover member 122 may be used to structurally connect the lower electrical connector 108 to the upper electrical connector 114. The cover member 122 may comprise an at least substantially hollow member that defines an inner cavity in which the electrical light sources 120 may be disposed. At least a portion of the cover member 122 may comprise a translucent material. By way of example, the cover member 122 may comprise a translucent polymer material. Accordingly, at least some light emitted by the electrical light sources 120 may pass through the cover member 122. The cover member 122 may be transparent in some embodiments. In other embodiments, the cover member 122 may diffuse light emitted by the electrical light sources 120 such that only some of the light passes through the cover member 122. The cover member 122 may also include holes formed therethrough, which may enable light emitted by the electrical light sources 120 to pass from the internal cavity of the cover member 122 to an exterior of the cover member 122. The translucent material of the cover member 122 may be colored in some embodiments. For example, the translucent material of the cover member 122 may absorb at least some wavelengths of visible light while permitting other wavelengths of light to pass through, thereby imparting a desired hue to the light that passes through the cover member 122. In other embodiments, the translucent material of the cover member 122 may be patterned with opaque designs, or with two or more colors of translucent material.

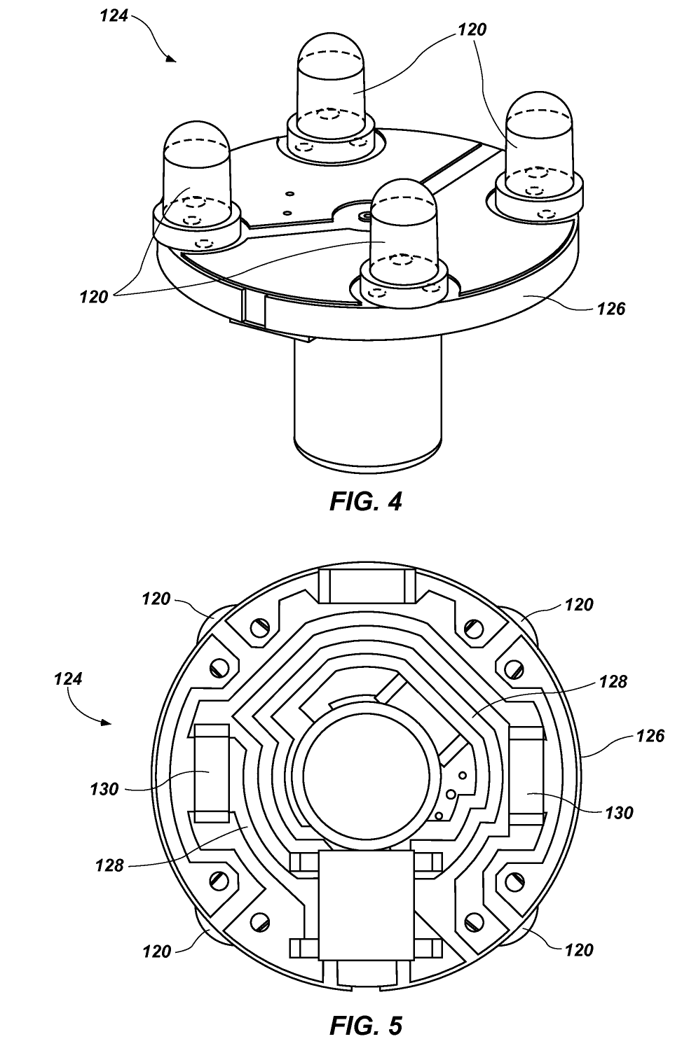

Referring to FIG. 4, a perspective view of an assembly 124 of electrical light sources 120 that may be used with the lighting module 106 of FIGS. 2 and 3 is shown. The electrical light sources 120 may be provided in an array on a carrier substrate 126, such as, for example, a printed circuit board, which may structurally connect and support the electrical light sources 120. The electrical light sources 120 may be filamentless. For example, the electrical light sources 120 may comprise light emitting diodes (LEDs) or compact fluorescent lamps (CFLs). In embodiments where the electrical light sources 120 comprise LEDs, the electrical light sources 120 may comprise single-colored LEDs or LEDs of a design capable of changing color. For example, the electrical light sources 120 may comprise an array of LEDs capable of emitting red, green, and blue light, alone or in combination with one another, sometime referred to as “RGB LEDs.” Thus, the electrical light sources 120, the cover member 122 (see FIGS. 2 and 3), or both may act to impart a hue to light emitted by the lighting module 106 (see FIGS. 2 and 3).

Referring to FIG. 5, a plan view from below the assembly 124 of electrical light sources 120 of FIG. 4 depicts circuitry that may be used with the assembly of electrical light sources 120. The carrier substrate 126 may comprise an electrically conductive material configured to electrically communicate with the lower electrical connector 108 of a lighting module 106 (see FIGS. 2 and 3) and with the electrical light sources 120. For example, the carrier substrate 126 may include metal traces 128 disposed on a surface thereof in electrical communication with the electrical light sources 120 and configured to electrically communicate with the lower electrical connector 108 of a lighting module 106 (see FIGS. 2 and 3). The carrier substrate 126 may also comprise circuitry 130 configured to control at least one of intensity, flickering, and coloring of visible light emitted by the electrical light sources 120. For example, the carrier substrate 126 may comprise circuitry 130 in electrical communication with the electrical light sources 120 via the traces 128 that may be configured to change at least one of intensity, flickering, and coloring of electrical light sources 120 comprising LEDs in response to a user input. In addition or in the alternative, the circuitry 130 may be configured to convert Alternating Current (AC) electrical power to Direct Current (DC) electrical power, known in the art as an AC rectifier circuit. As a specific, nonlimiting example, the circuitry 130 may enable a user to selectively change the electrical light sources 120 from emitting substantially constant white light of a first intensity to emitting flickering yellow light of a second, dimmer intensity. In another non-limiting example, circuitry 130 may comprise one or more power conversion modules to reduce household power (e.g., current) input to electrical light sources 120, or to upper electrical connector 114, or both, as desired.

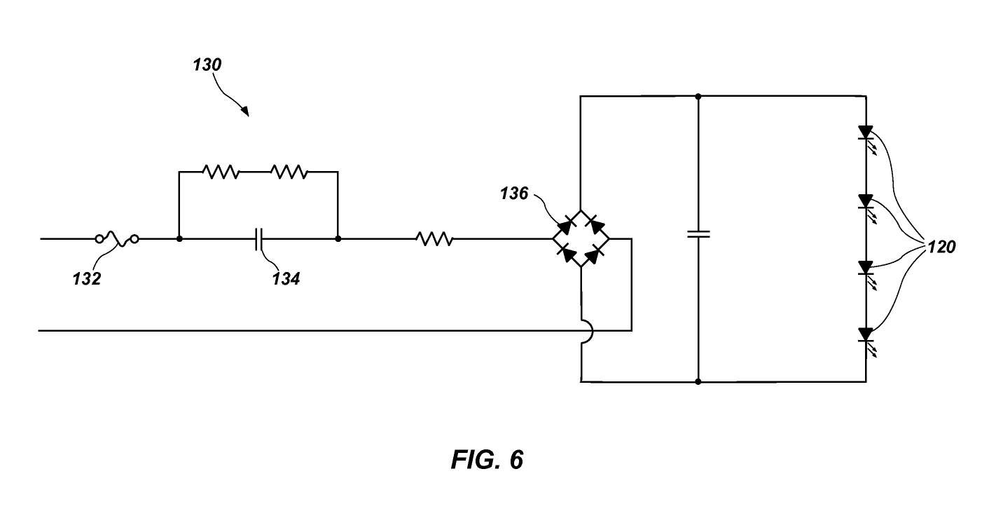

Referring to FIG. 6, one embodiments of a circuit diagram of a circuit 130 that may be used with the assembly 124 of electrical light sources 120 of FIG. 4 is shown. As depicted, the circuit 130 may comprise a fuse 132 configured to prevent excessive and potentially damaging current levels from flowing through the circuit 130, for example, to electrical light sources 120. For example, the fuse 132 may comprise a 200 mA fuse. The circuit 130 may also comprise a parallel resistor-capacitor (RC) circuit 134. For example, the parallel RC circuit 134 may comprise resistors having a total resistance of 660 kΩ in parallel with capacitors having a total capacitance of 0.33 μF. The capacitor in the parallel RC circuit 134 may diminish the amplitude and fluctuation of current (e.g., fluctuation of direct current, fluctuation of alternating current, or simply high amplitude portions of alternating current) flowing through the circuit 130, while the resistors may enable the capacitor to discharge after the circuit 130 has been disconnected from an electrical power source. Additional resistors, capacitors, and other electrical components may be used, as needed or desired. The circuit 130 may include a diode bridge 136 configured to provide the same polarity output regardless of the polarity of input to the circuit 130. By including a reservoir capacitor 138 in parallel with the electrical light sources 120, the circuit 130 may act as an AC rectifier due to the smoothing provided by the reservoir capacitor 138 in connection with the diode bridge 136.

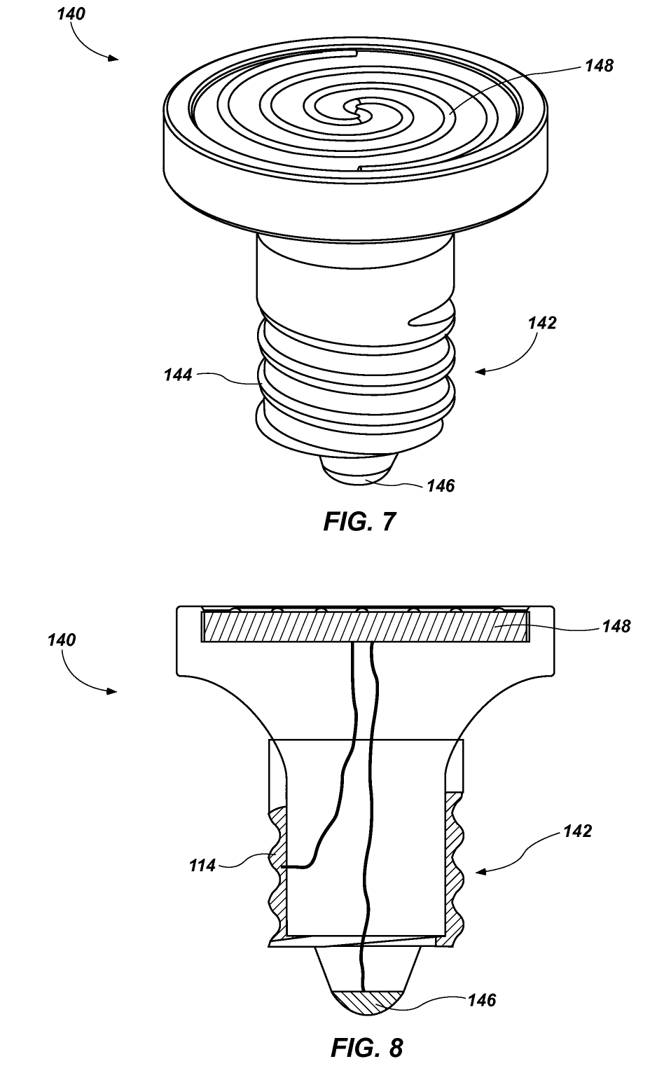

Referring to FIGS. 7 and 8, a perspective view and a cross-sectional view of a heating module 140 that may be used with a scent warmer are shown, respectively. The heating module 140 may comprise a lower electrical connector 142 configured for physical and electrical engagement with an upper electrical connector 114 of a lighting module 106 (see FIGS. 2 and 3). The lower electrical connector 142 may be disposed at a lower portion of the heating module 140. The lower electrical connector 142 may comprise at least one helically extending protrusion 144 configured to threadedly engage and electrically communicate with the helically extending recess 116 of an upper electrical connector 114 of a lighting module 106 and at least one contact 146 configured to electrically communicate with the contact 118 of the upper electrical connector 114 of the lighting module 106 (see FIGS. 2 and 3) to form a closed electrical path. At least a portion of the lower electrical connector 142 may comprise an electrically conductive material and may be configured to receive electrical power from the upper electrical connector 114 of the lighting module 106 (see FIGS. 2 and 3).

The heating module 140 may comprise a heating element 148. The heating element 148 may be disposed at an upper portion of the heating module 140 above the lower electrical connector 142. Thus, the heating element 148 may be located at an end of the heating module 140 opposing the lower electrical connector 142. The heating element 148 may be electrically connected to the lower electrical connector 142 and configured to receive electrical power therefrom. The heating element 148 may comprise, for example, a resistive element, such as a filament-type or ceramic element, an infrared element, a Peltier-type element, a thermocouple element, or an inductive heating element, which would heat a receptacle having a ferrous lining or insert.

The heating element 148 may be configured to heat to a temperature suitable for warming a scented material. The heating element 148 may also be configured to only heat to a temperature sufficiently low that the scented material being warmed does not ignite and that the heating module 140 and any other devices near the heating element 148 retain structural integrity (i.e., do not experience catastrophic failure due to temperature-induced weakening of the materials from which they are formed). For example, the heating element 148 may be configured to heat to a temperature of between about 45° C. and 70° C. As a continuing example, the heating element 148 may be configured to heat to a temperature of between about 50° C. and about 60° C. In one nonlimiting example, heating module 140 may incorporate a power conversion module to reduce household power (e.g., current) input. Another approach is incorporation of a thermocouple in the circuit to remove power from heating element 148 when the temperature becomes undesirably high.

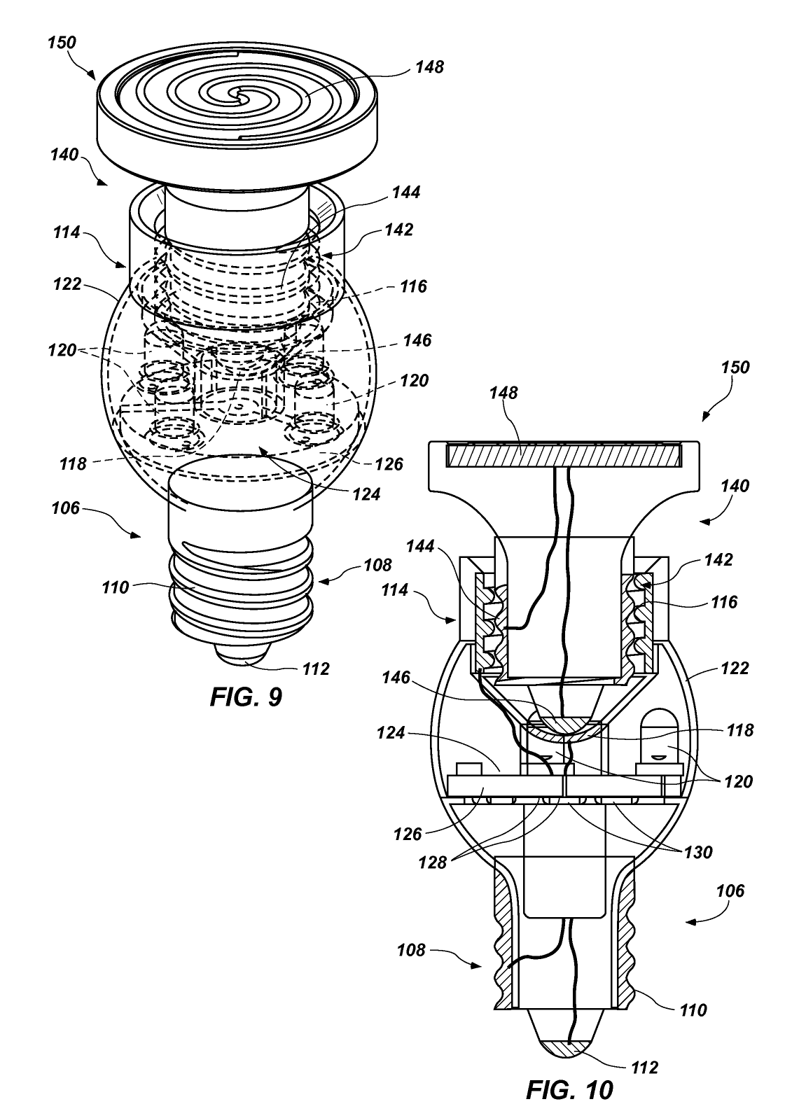

Referring to FIGS. 9 and 10, a perspective view and a cross-sectional view of an assembly 150 of the lighting module 106 of FIGS. 2 and 3 with the heating module 140 of FIGS. 7 and 8 are shown, respectively. The lower electrical connector 142 of the heating module 140 may be threadedly engaged with the upper electrical connector 114 of the lighting module 106. Thus, the assembly 150 may be configured to emit both light and heat using the lighting module 106 and the heating module 140, respectively.

When assembling the assembly 150, the heating module 140 may be positioned over the lighting module 106, and the lower electrical connector 142 of the heating module 140 may be aligned with the upper electrical connector 114 of the lighting module 106. The heating module 140 may be simultaneously lowered and rotated with respect to the lighting module 106. Thus, the helically extending protrusion 144 of the lower electrical connector 142 of the heating module 140 may engage with the helically extending recess 116 of the upper electrical connector 114 of the lighting module 106. As the lower electrical connector 142 of the heating module 140 proceeds downwardly into the upper electrical connector 114 of the lighting module 106, the contact 146 of the lower electrical connector 142 of the heating module 140 may abut the contact 118 of the upper electrical connector 114 of the lighting module 106 to form a closed electrical path. For example, the electrical connection thus formed may comprise a pass-through electrical connection. Thus, electrical power provided to the lower electrical connector 108 of the lighting module 106 may be transmitted to both the lighting module 106 and the heating module 140, and the components thereof For example, a single electrical power source may transmit electrical power to the lower electrical connector 108 of the lighting module 106, the electrical light sources 120 of the lighting module 106, the upper electrical connector 114 of the lighting module 106, the lower electrical connector 142 of the heating module 140, and the heating element 148 of the heating module 140.

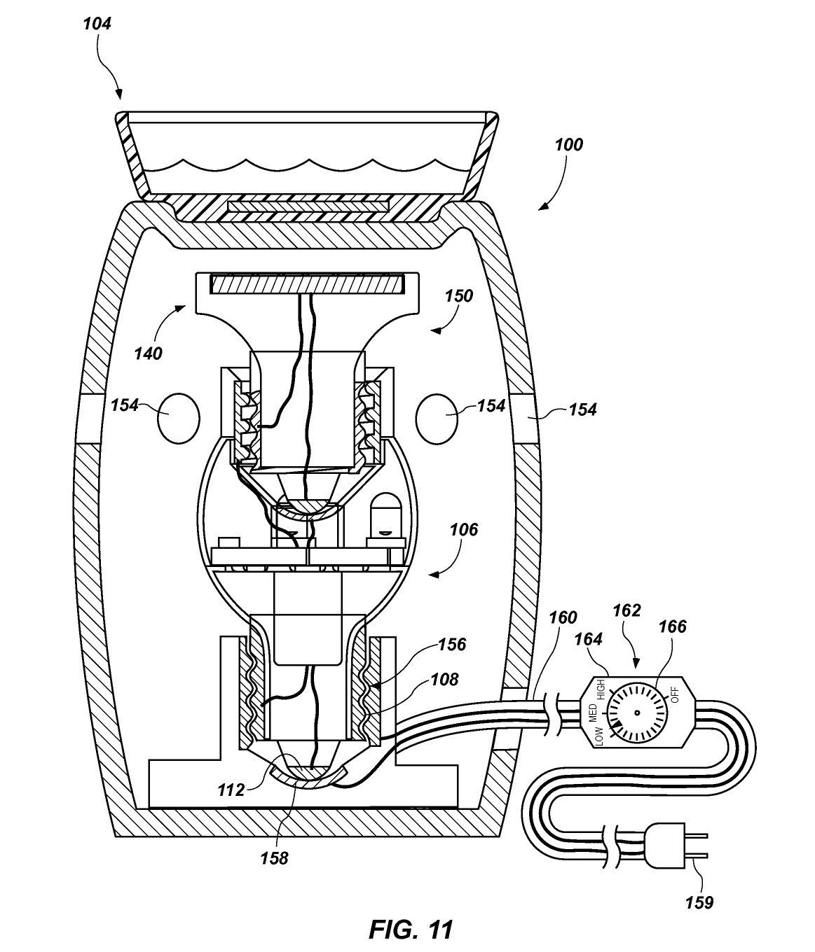

Referring to FIG. 11, a simplified cross-sectional view of an embodiment of the warming device 100 is shown including the assembly 150 comprising the lighting module 106 and heating module 140 disposed in the decorative base 102. The decorative base 102 of the warming device 100 comprises an at least substantially hollow portion 152 defining a cavity configured to receive at least one lighting module, such as lighting module 106, and at least one heating module, such as heating module 140, at least partially therein. The at least substantially hollow portion 152 may comprise at least one light hole 154 formed in a side surface thereof For example, the at least substantially hollow portion 152 may comprise a plurality of light holes 154 through which at least some light is allowed to pass. Thus, the at least substantially hollow portion 152 may be configured to permit light emitted by the lighting module 106 to pass from an interior of the at least substantially hollow portion 152 to an exterior of the at least substantially hollow portion 152.

The decorative base 102 may comprise a female threaded electrical connector 156. The female threaded electrical connector 156 may be disposed at a lower portion of the decorative base 102. Thus, the decorative base 102 may be configured to receive the lower electrical connector 108 of a lighting module 106, a male threaded electrical connector 142 of a heating module 140, or both in embodiments where the base structure comprises a plurality of female threaded electrical connectors 156. The female threaded electrical connector 156 may comprise at least one helically extending recess configured to threadedly engage and electrically communicate with the helically extending protrusion 110 of the lower electrical connector 108 of the lighting module 106, the helically extending protrusion 144 of the lower electrical connector 142 of the heating module 140, or both. In addition, the female threaded electrical connector 156 may include at least one contact 158 configured to communicate with the contact 112 of the lower electrical connector 108 of the lighting module 106, the contact 146 of the lower electrical connector 142 of the heating module 140, or both to form a closed electrical path. At least a portion of the female threaded electrical connector 156 may comprise an electrically conductive material and may be in electrical communication with the lower electrical connector 108 of the lighting module 106 or the lower electrical connector 142 of the heating module 140. For example, a pass-through electrical connection may provide electrical communication between the lower electrical connector 108 of the lighting module 106, the lower electrical connector 142 of the heating module 140, and the female threaded electrical connector 156 of the decorative base 102. Thus, a single power source may provide electrical power to the decorative base 102, the lighting module 106 connected to the base structure, and the heating module 140 connected to the lighting module 106. In other words, a single power source may provide electrical power for the warming device 100.

The decorative base 102 may comprise an electrical power source interface 159, such as, for example, a standard electrical power plug, in electrical communication with the female threaded electrical connector 156 of the decorative base 102 by a conventional, flexible power cord 160 configuration. The power cord 160 may optionally comprise a user control regulator 162 for controlling the temperature of the heating element 148 and, by extension, the warming dish 104. In this manner, the temperature of the warming dish 104 may be controlled to achieve an optimum temperature in accordance with a specific food product being warmed by the warming dish 104. As shown, the regulator 162 may include a handle portion 164 having a knob 166 operatively coupled thereto and configured to allow a user to adjust the temperature setting of the heating element 148 and, by extension, the warming dish 104 by manipulating the knob 166 between a high, medium and low setting. In embodiments where the decorative base 102 utilizes an incandescent light bulb to heat the warming dish 104, the regulator 162 may operate as a dimmer switch. Without a regulator 162, a 25 watt incandescent light bulb may heat the warming dish 104 to temperatures in excess of ideal temperatures for warming certain food products. For example, a 25 watt incandescent light bulb may result in the food product being heated to a temperature in the range extending from about 73.9° C. (165° F.) to about 93.3° C. (200° F.). Such temperatures may be too high for melting chocolate, cheese, or other sauces. At such high temperatures, these types of foods may decompose or degrade in a manner affecting the consistency and/or flavor of the foods. For example, chocolate may begin to scald at about 70° C. (158° F.), which is why chocolate is often melted using indirect heat (e.g., using a double boiler configuration). Thus, the regulator 162 allow a user to dim the incandescent light bulb, thus reducing the temperature of the light bulb and, by extension, the warming dish 104 to an ideal temperature in accordance with a specific food being warmed by the warming dish 104.

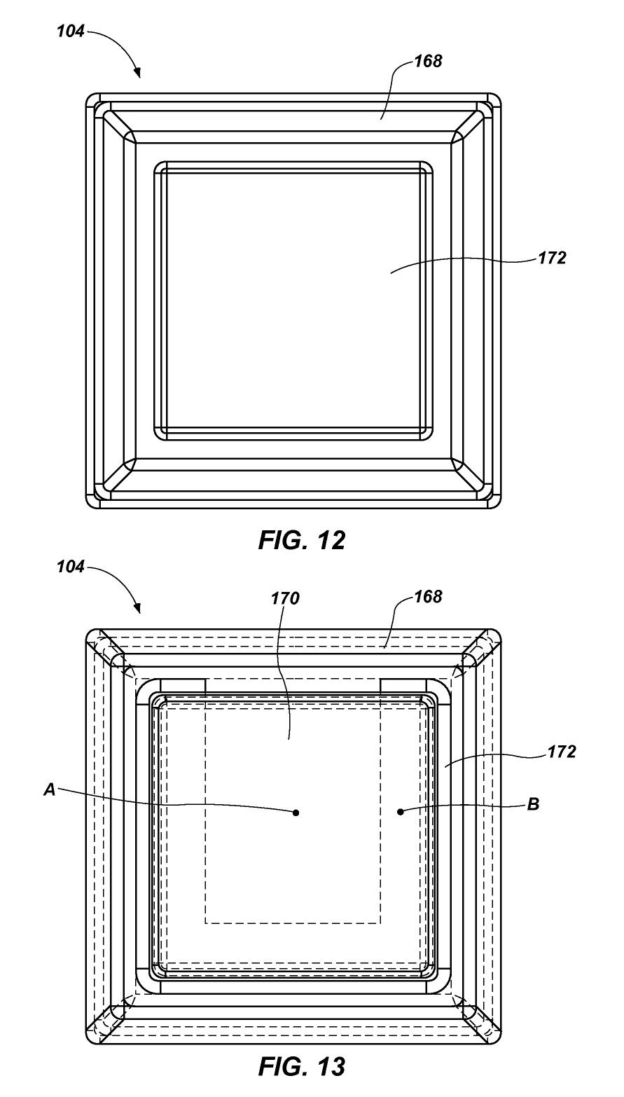

Referring now to FIGS. 12 through 15, embodiments of a warming dish configured for use with the decorative base 102 are illustrated. In some embodiments, the warming dish 104 may differ from warming dishes previously used with typical flameless candle warmers, and may have particular thermal properties desirable for heating food within the warming dish 104.

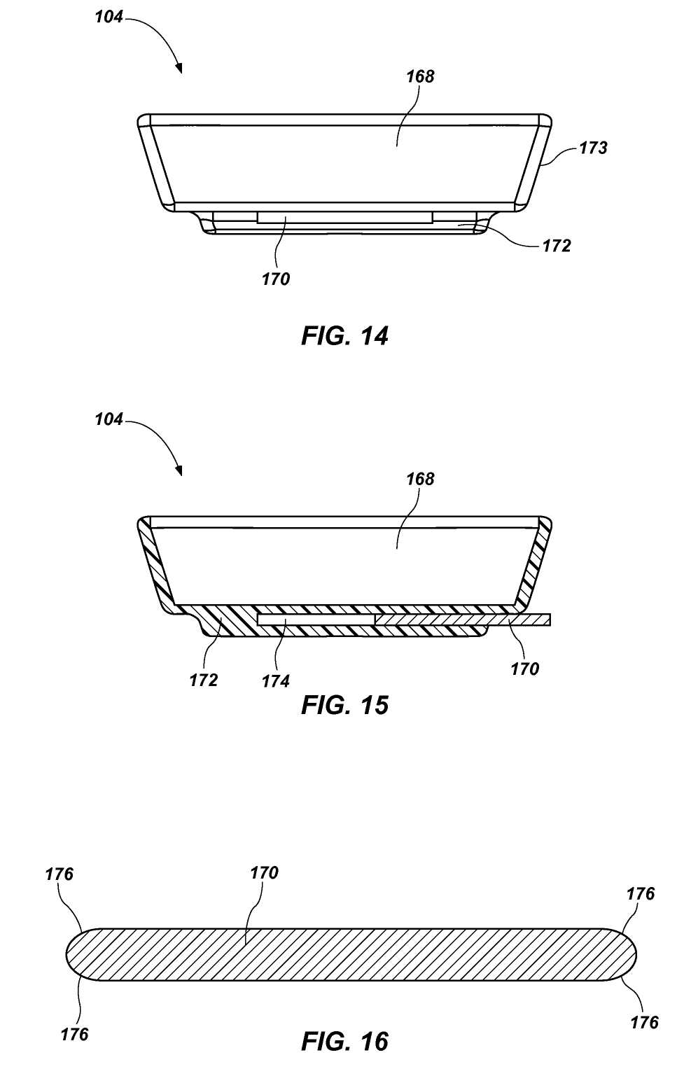

FIGS. 12 through 14 illustrate different views of the warming dish 104 of FIG. 1, separate from the decorative base 102. As shown in FIGS. 12 through 14, the warming dish 104 comprises a main body 168 having a base portion 172 with integral, upwardly oriented side walls 173 enclosing an interior volume suitable for containing a volume of liquid. The bottom side of the base includes a ridge, configured to allow the warming dish 104 to rest securely atop the decorative base in close proximity to the heating assembly. In the embodiment shown in the figures, the bottom side of the warming dish 104 includes a ridge defining a generally square shape, which nests inside the top edge of the decorative base 102. This ridge is best viewed in FIG. 14. It will be apparent that dishes of other shapes can also be used. For example, while the warming dish 104 shown in the figures is generally square in the horizontal dimension, suitable dishes can be provided for warming devices of other shapes (e.g., circular, hexagonal, etc.).

The warming dish 104 may have a main body 168 defining at least the food-contacting surfaces of the warming dish 104. The main body 168 of the warming dish 104 may comprise a material suitable for use with food products, which material may exhibit a relatively low thermal conductivity. For example, the material of the main body 168 may exhibit a thermal conductivity in a range extending from about 0.12 W/mK to about 0.40 W/mK (at room temperature). In one particular embodiment, the main body 168 of the warming dish 104 may comprise a polymer, such as silicone (e.g., a food grade silicone). Various suitable silicone materials are commercially available, and may be injection molded or otherwise formed into any desirable shape, and may have any desirable color. Other materials that have suitable thermal properties may also be used, including, by way of non-limiting example, ceramic materials, such as porcelain. The warming dish 104 may also be provided with a variety of decorative features, as desired. Advantageously, food grade silicone is flexible and resistant to both high and low temperatures. For example, food grade silicone materials may be suitable for use throughout a temperature range extending from about −23.3° C. (−10.0° F.) to as high as 260° C. (500° F.). In embodiments in which the warming dish 104 is flexible, the warming dish 104 may be resistant to breaking if dropped, and may not be damaged by long-term proximity to a heat source, such as an incandescent light bulb or another type of heating element. Food grade silicone may also be used safely in microwave ovens and dishwashers.

A heat spreader 170, such as a generally planar plate-like structure, may be disposed within or on a base portion 172 of the warming dish 104. The heat spreader 170 may comprise a material that exhibits a relatively high thermal conductivity, such as about 100 W/mK or more, about 200 W/mK or more, or even about 250 W/mK or more (at room temperature). As a non-limiting example, the heat spreader 170 may comprise a metal or metal alloy, such as aluminum. In some embodiments, the heat spreader 170 may be encased within the base portion 172 of the warming dish 104. This can be accomplished by injection molding the warming dish 104 material around the heat spreader 170. In this configuration, a layer of the material of the main body 168 (e.g., silicone) having a thickness of about 0.38 cm (0.15 inch) may be provided above the heat spreader 170, and a layer of the material of the main body 168 (e.g., silicone) having a thickness of about 0.20 cm (0.08 inch) may be provided below the heat spreader 170.

While the metal heat spreader 170 is embedded or encased within the base portion 172 of the warming dish 104 in the illustrated embodiments, other configurations also may be used. For example, a metal heat spreader 170 may be attached to an exposed lower surface of the base portion 172 of the warming dish 104, or a heat spreader 170 may be attached to an exposed upper surface of the base portion 172 of the warming dish 104 within the volume of the warming dish 104 that holds the food product, such that an exposed surface of the heat spreader 170 defines a food-contacting surface of the warming dish 104.

As a non-limiting example embodiment, the metal heat spreader 170 comprises a generally planar aluminum plate having an average thickness of approximately 0.33 cm (0.13 inch), a length of about 5.08 cm (2 inches), and a width of about 5.08 cm (2 inches), and is positioned approximately at a center of the base portion 172 of the warming dish 104. The interior food-contacting lower surface of the warming dish 104 may have a length and width, each of which may be about 8.26 cm (3.25 inches), thus leaving a border region about 1.588 cm (0.625 inch) wide extending around a perimeter of the metal heat spreader 170. Thus, the metal heat spreader 170 is not disposed directly below this border region. It is to be appreciated that this is only one possible configuration for the metal heat spreader 170. Other metals and other shapes and sizes can also be used.

In further alternative embodiments, as illustrated in FIG. 15, the heat spreader 170 may be insertable into, and removable from, the base portion 172 of the warming dish 104. FIG. 15 illustrates the heat spreader 170 partially inserted into the base portion 172. The base portion 172 may define a recess 174 configured to receive the heat spreader 170 therein. The recess 174 may be sized and configured to securely maintain the heat spreader 170 therein after insertion while allowing ease of insertion of the heat spreader 170 into the recess 174 and removal of the heat spreader 170 out from the recess 174.

In some embodiments, as shown in FIG. 16, the heat spreader 170 may have rounded edges 176 to prevent the heat spreader 170 from arcing electrical current when placed in a microwave oven. In this manner, the warming dish 104 having the heat spreader 170 therein may be placed in a microwave oven, if desired (e.g., to reduce the time to heat up the warming dish 104). In embodiments where the heat spreader 170 is removable from the warming dish 104, the heat spreader 170 may be removed from the warming dish 104, heated in a microwave oven, and inserted back into the warming dish 104 after heating in the microwave. In yet other embodiments where the heat spreader 170 is removable from the warming dish 104, the heat spreader 170 may be removed from the warming dish 104, the warming dish 104 (without the heat spreader 170 therein) may be heated in a microwave oven, and the heat spreader 170 may be inserted back into the warming dish 104 after the warming dish 104 is removed from the microwave. In yet even further embodiments, the warming dish 104 may be used without the heat spreader 170 therein.

The metal heat spreader 170 in the base portion 172 of the warming dish 104 may allow thermal energy from the incandescent bulb or other heating element within the decorative base 102 to be transmitted by the heat spreader 170 to the material of the main body 168 of the warming dish 104, which may exhibit a relatively lower thermal conductivity. This may regulate and moderate a temperature of the warming dish 104 during use. Previously known warming dishes for use with flameless candle warmers are frequently made of ceramic porcelain or other material. Such materials may exhibit thermal conductivities between those of metal and those of many dielectric polymers, such as silicone. As previously mentioned, typical flameless candle warmers may heat scented wax therein to a temperature in the range extending from about 73.9° C. (165° F.) to about 93.3° C. (200° F.). Such temperatures may be too high for melting chocolate, cheese, or other sauces. At such high temperatures, these types of foods may decompose or degrade in a manner affecting the consistency and/or flavor of the foods. For example chocolate may begin to scald at about 70° C. (158° F.), which is why chocolate is often melted using indirect heat (e.g., using a double boiler configuration).

Advantageously, even without use of a regulator, such as regulator 162 previously described in reference to FIG. 11, a warming dish 104 that comprises both a heat spreader 170 that exhibits relatively high thermal conductivity and a main body 168 that exhibits a relatively low thermal conductivity may regulate and moderate a temperature of the warming dish 104 and any food therein to maintain a lower peak and/or steady-state temperature. In testing, a warming dish 104 as disclosed herein was placed above a 25 watt incandescent light bulb for 45 minutes. During this time of heating, an infrared thermometer was used to measure the temperature of the interior exposed lower surface of the warming dish 104 (the surface which would contact the food product) at the center of the warming dish 104 (above the metal heat spreader 170), approximately designated point A in FIG. 13, and in the perimeter region slightly away from the metal heat spreader 170, at a point approximately designated point B in FIG. 3. The following temperature readings were found:

| | | Silicone | |
|---|---|---|---|
| | Center Temp. | Perimeter Temp | Difference |
| Time (min.) | (Point A) (° C./° F.) | (Point B) (° C./° F.) | (° C./° F.) |
| 0 | 25/77 | 25/77 | 0/0 |
| 5 | 36.2/97.1 | 33.4/92.1 | 2.8/5.0 |
| 10 | 51.8/125.2 | 44.6/112.3 | 7.2/12.9 |
| 15 | 62.4/144.3 | 48.7/119.6 | 13.7/24.7 |
| 20 | 673.6/153.7 | 55.3/131.6 | 12.3/22.1 |
| 25 | 74.1/165.3 | 60.7/141.2 | 13.4/24.1 |
| 30 | 75.8/168.4 | 63.2/145.8 | 12.6/22.6 |
| 45 | 79.7/175.4 | 66.3/151.3 | 13.4/24.1 |

This temperature data shows that the low thermal conductivity material of the main body 168 of the warming dish 104 maintains the overall temperature relatively low and stable. As can be seen, the warming dish 104 reached a maximum temperature of about 80° C. (175° F.) in a region adjacent to the heat spreader 170, and a maximum temperature of about 66° C. (150° F.) in a region away from the heat spreader 170. These become relatively steady state temperatures, allowing the warming dish 104 to function well for chocolate, cheese, sauces, fondue-type foods, etc. Furthermore, using the warming dish 104, as described in reference to FIGS. 12 through 14, in combination with the regulator 162, described in reference to FIG. 11, allows for yet further control and optimization of the temperature of the food in the warming dish 104.

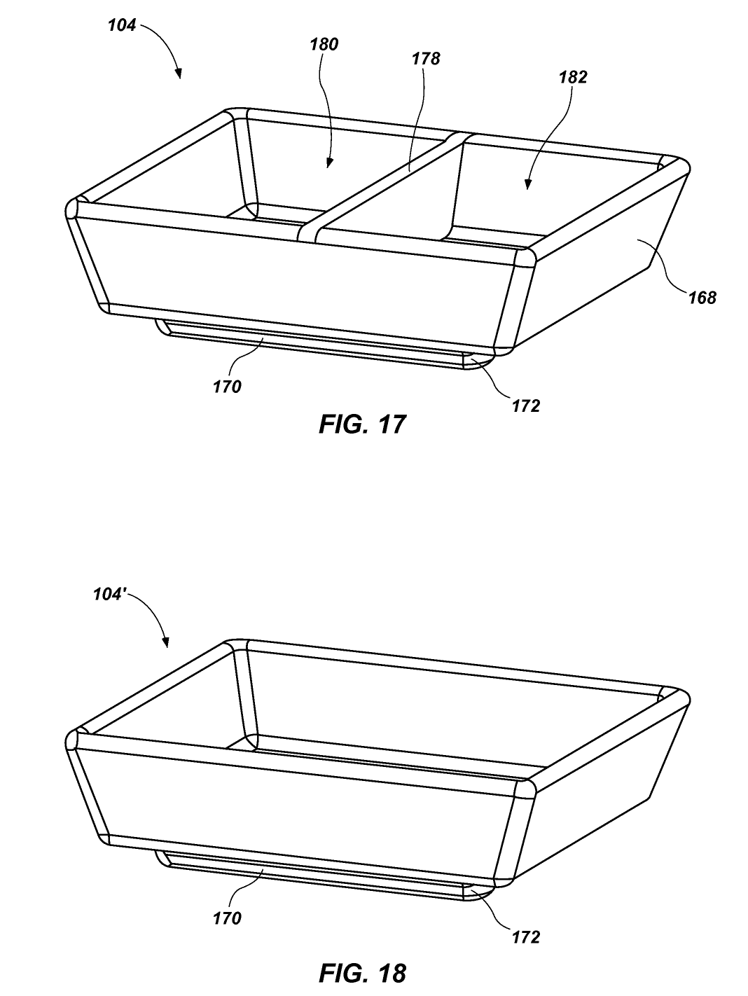

In additional embodiments, as shown in FIG. 17, the warming dish 104 may include a divider 178 partitioning the main body 168 into two or more separate portions 180, 182 each suitable for containing a volume of liquid. Such a configuration allows for multiple food products to be warmed simultaneously in the warming dish 104. The divider may extend upwardly from the base portion 172 and between the side walls 173 of the main body 168. The divider 178 may be continuous with and comprise the same material as the main body 168 and the base portion 172. In such embodiments, the warming dish 104 and the divider 178 may be integrally formed by a single injection molding process.

The warming dish 104 shown in FIGS. 11 through 17 is generally square in shape. In other embodiments warming dishes according to embodiments of the present disclosure may have any shape configured to rest upon a decorative base 102 of a flameless warming device 100. For example, FIG. 18 illustrates another embodiment of a warming dish 104′ of the present disclosure that has a generally rectangular shape. Any other shapes may also be employed.

Warming dishes 104, 104′ disclosed herein can be provided as part of a candle and food warming system. For example, in additional embodiments, a candle and food warming system may include a flameless warming device 100 like that previously described, which includes a decorative base 102 and a warming dish 104 for warming food above the decorative base 102, but further including one or more additional warming dishes for heating scented wax. Such an additional warming dish may have a size and shape similar to that of the warming dish 104 so as to be usable with the same decorative base 102, but may comprise porcelain or other ceramic material.

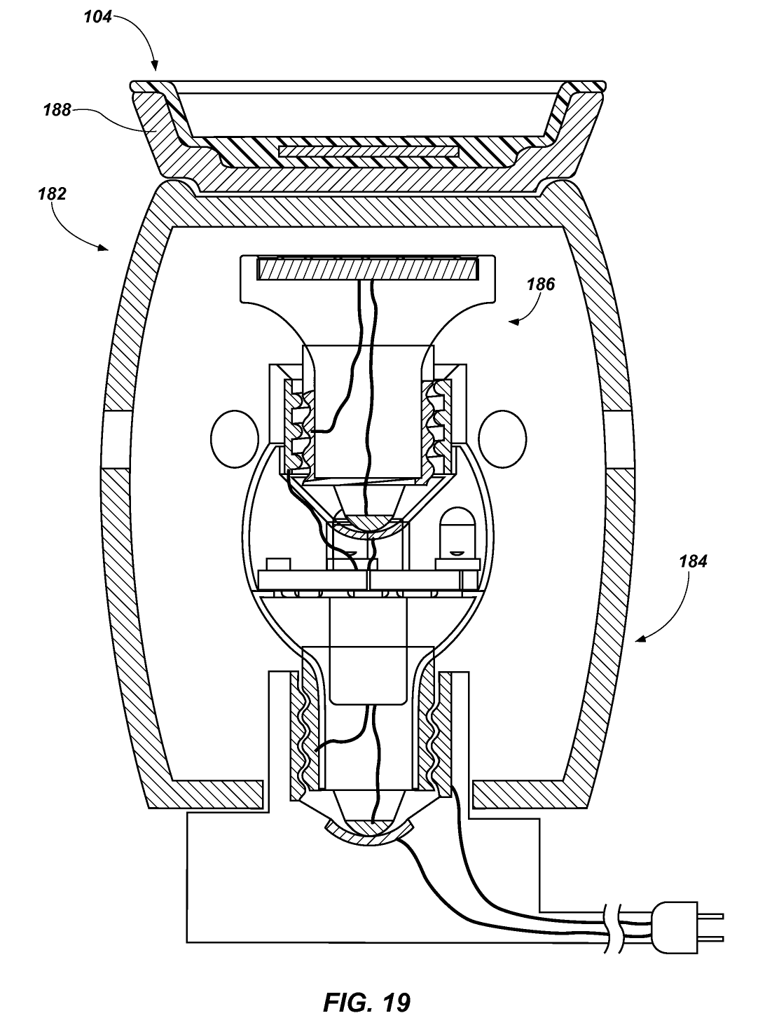

In additional embodiments, a warming dish 104 for wan ling food as described herein may be manufactured and sold as an accessory for use with conventional flameless candle warmers. For example, as shown in FIG. 19, a conventional flameless candle warmer 182 may include a decorative base 184, a heat source 186, and a porcelain warming dish 188. The warming dish 104, configured as previously described herein, may be configured to rest upon the porcelain warming dish 188 as shown in FIG. 19. The warming dish 104 may provide a useful accessory that allows a flameless candle warmer to also be used for heating foods. This provides additional utility to conventional flameless candle warmers and provides an additional device for use in social gatherings.

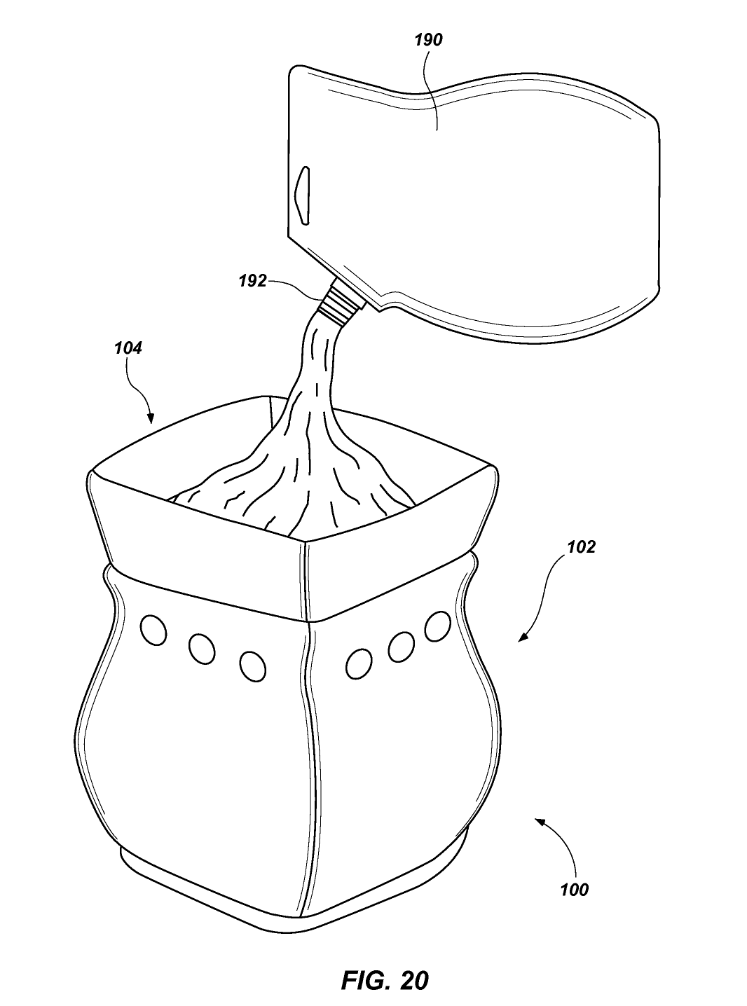

In further embodiments, as shown in FIG. 20, the warming device 100 may be used to warm chocolate that has previously been melted in microwavable packages 190. The microwavable packages 190 may comprise a plastic material encasing chocolate pieces therein. Many types of chocolate form unsightly whitish or grey marks (commonly referred to in the art as “bloom”) if the chocolate has been exposed to excessive heat after making the chocolate. Bloom may result from the breakdown of the crystalline structure of cocoa butter, with some of the cocoa butter migrating to the surface of the chocolate. Bloom often occurs during shipping and storage of chocolate products, and the prevention of bloom can be a considerable challenge when most consumers view bloom as reducing the quality of the chocolate. While bloom may be unsightly to chocolate consumers, it may be removed by subsequently melting the chocolate. The packages 190 are opaque, thus preventing consumers from actually viewing the chocolate, and any bloom thereon, contained in the packages 190. The packages 190 are configured to be used in a microwave oven to melt the chocolate contained therein. The packages 190 comprise an integral spout 192 formed thereon from which the melted chocolate may be poured into the warming dish 104 of warming device 100. In this manner, the chocolate contained in the packages 190 may be melted before the consumer has an opportunity to view any bloom formed on the chocolate. The packages 190 may be used in connection with any embodiments of the present disclosure described herein.

Additional non-limiting example embodiments are set forth below.

Embodiment 1: A warming dish for use with a flameless warming device, comprising: a main body including a base portion and side walls integral with and upwardly extending from the base portion, the base portion sized and configured to rest upon a base of a flameless warming device, the side walls and the base portion together defining an interior volume of the warming dish for containing a volume of liquid, the main body comprising a material exhibiting a relatively low thermal conductivity; and a heat spreader comprising a material exhibiting a relatively high thermal conductivity in direct physical contact with the base portion of the main body such that thermal energy generated by a base of a flameless warming device is transmitted by the heat spreader to the base portion of the main body to regulate and moderate a temperature of the base portion during use.

Embodiment 2: The warming dish of Embodiment 1, wherein the material of the main body exhibits a thermal conductivity in a range extending from about 0.12 W/mK to about 0.4 W/mK.

Embodiment 3: The warming dish of Embodiment 1 or Embodiment 2, wherein the material of the main body comprises a polymer.

Embodiment 4: The warming dish of Embodiment 3, wherein the polymer comprises a flexible polymer.

Embodiment 5: The warming dish of Embodiment 3 or Embodiment 4, wherein the polymer comprises silicone.

Embodiment 6: The warming dish of Embodiment 5, wherein the silicone comprises food grade silicone.

Embodiment 7: The warming dish of any one of Embodiments 1 through 6, further comprising a divider extending upwardly from the base portion and between the side walls, the divider being integral with the base portion and the sidewalls, the divider partitioning the warming dish into two or more interior volumes, each volume of the two or more interior volumes for containing a volume of liquid.

Embodiment 8: The warming dish of any one of Embodiments 1 through 7, wherein the material of the heat spreader exhibits a thermal conductivity of at least about 100 W/mK.

Embodiment 9: The warming dish of Embodiment 8, wherein the material of the heat spreader exhibits a thermal conductivity of at least about 200 W/mK.

Embodiment 10: The warming dish of Embodiment 9, wherein the material of the heat spreader exhibits a thermal conductivity of at least about 250 W/mK.

Embodiment 11: The warming dish of any one of Embodiments 1 through 10, wherein the heat spreader comprises a metal or metal alloy.

Embodiment 12: The warming dish of Embodiment 11, wherein the metal or metal alloy comprises aluminum.

Embodiment 13: The warming dish of any one of Embodiments 1 through 12, wherein the heat spreader comprises a generally planar plate.

Embodiment 14: The warming dish of any one of Embodiments 1 through 13, wherein the heat spreader includes rounded edges configured to prevent electric arcs from forming between separate potions of the heat spreader when the heat spreader is placed in a microwave oven.

Embodiment 15: The warming dish of any one of Embodiments 1 through 14, wherein the heat spreader is embedded within the base portion of the main body.

Embodiment 16: The warming dish of any one of Embodiments 1 through 15, wherein a first layer of the material of the main body having a thickness of about 0.38 cm (0.15 inch) extends above the plate, and a second layer of the material of the main body having a thickness of about 0.20 cm (0.08 inch) extends below the plate.

Embodiment 17: The warming dish of any one of Embodiments 1 through 16, wherein the base portion of the main body is configured to reach a maximum temperature of about 80° C. (175° F.) or less in a central region of the base portion over the heat spreader, and to reach a maximum temperature of about 66° C. (150° F.) or less in a peripheral region of the base portion.

Embodiment 18: A flameless warming device, comprising: a decorative base including a heater for generating thermal energy, the heater comprising at least one of an incandescent light bulb and a heating element; and a warming dish as recited in any one of Embodiments 1 through 17, the warming dish configured to rest atop the decorative base, the warming dish being removable from the decorative base.

Embodiment 19: The flameless warming device of any Embodiments 18, further comprising a second warming dish consisting of a ceramic material, the second warming dish configured to rest atop the decorative base between the decorative base and the warming dish.

Embodiment 20: The flameless warming device of Embodiments 18 or Embodiment 19, further comprising a regulator in electronic communication with the heater, the regulator comprising a handle and a control knob for controlling the temperature of the heater.

Embodiment 21: A method of serving melted chocolate, comprising: providing a warming dish as recited in any one of Embodiments 1 through 15; heating a substantially enclosed opaque container carrying chocolate therein in a microwave oven until the chocolate is melted; and pouring the melted chocolate from a spout integrally formed on the opaque container and into the warming dish.

Embodiment 22: A method of manufacturing a warming dish for use with a flameless warming device, the method comprising: forming a main body including a base portion and side walls integral with and upwardly extending from the base portion and sizing and configuring the base portion to rest upon a base of a flameless warming device, the side walls and the base portion together defining an interior volume of the warming dish for containing a volume of liquid, the main body comprising a material exhibiting a relatively low thermal conductivity; and providing a heat spreader comprising a material exhibiting a relatively high thermal conductivity in direct physical contact with the base portion of the main body such that thermal energy generated by a base of a flameless warming device is transmitted by the heat spreader to the base portion of the main body to regulate and moderate a temperature of the base portion during use.

Embodiment 23: The method of Embodiment 22, wherein forming the min body comprises injection molding the main body at least partially around the heat spreader.

Embodiment 24: The method of Embodiment 23, further comprising selecting the material of the main body to comprise silicone; and selecting the material of the heat spreader to comprise metal.

Embodiment 25: The method of Embodiment 24, further comprising selecting the metal to comprise aluminum.

It is to be understood that the particular embodiments described herein are only illustrative of the various embodiments of the present disclosure, which is defined by the claims set forth below. Numerous modifications and alternative arrangements in form, usage, and details of implementation can be devised without the exercise of inventive faculty, and without departing from the principles, concepts, and scope of the disclosure as defined by the claims below.

What is claimed is:

1. A warming dish for use with a flameless warming device, comprising:
a main body including a base portion and side walls integral with and upwardly extending from the base portion, the base portion sized and configured to rest upon a base of a flameless warming device, the side walls and the base portion together defining an interior volume of the warming dish for containing a volume of liquid, the main body comprising a material exhibiting a relatively low thermal conductivity; and
a heat spreader comprising a material exhibiting a relatively high thermal conductivity in direct physical contact with the base portion of the main body such that thermal energy generated by a base of a flameless warming device is transmitted by the heat spreader to the base portion of the main body to regulate and moderate a temperature of the base portion during use.

2. The warming dish of claim 1, wherein the material of the main body exhibits a thermal conductivity in a range extending from about 0.12 W/mK to about 0.4 W/mK.

3. The warming dish of claim 2, wherein the material of the main body comprises food-grade silicone.

4. The warming dish of claim 1, further comprising a divider extending upwardly from the base portion and between the side walls, the divider being integral with the base portion and the sidewalls, the divider partitioning the warming dish into two or more interior volumes, each volume of the two or more interior volumes for containing a volume of liquid.

5. The warming dish of claim 1, wherein the material of the heat spreader exhibits a thermal conductivity of at least about 100 W/mK.

6. The warming dish of claim 5, wherein the material of the heat spreader exhibits a thermal conductivity of at least about 250 W/mK.

7. The warming dish of claim 6, wherein the heat spreader comprises a metal or metal alloy.

8. The warming dish of claim 7, wherein the metal or metal alloy comprises aluminum.

9. The warming dish of claim 1, wherein the heat spreader comprises a generally planar plate.

10. The warming dish of claim 9, wherein the heat spreader includes rounded edges configured to prevent electric arcs from forming between separate potions of the heat spreader when the heat spreader is placed in a microwave oven.

11. The warming dish of claim 1, wherein the heat spreader is embedded within the base portion of the main body.

12. The warming dish of claim 1, wherein a first layer of the material of the main body having a thickness of about 0.38 cm (0.15 inch) extends above the plate, and a second layer of the material of the main body having a thickness of about 0.20 cm (0.08 inch) extends below the plate.

13. The warming dish of claim 1, wherein the base portion of the main body is configured to reach a maximum temperature of about 80° C. (175° F.) or less in a central region of the base portion over the heat spreader, and to reach a maximum temperature of about 66° C. (150° F.) or less in a peripheral region of the base portion.

14. A flameless warming device, comprising:
a decorative base including a heater for generating thermal energy, the heater comprising at least one of an incandescent light bulb and a heating element; and
a warming dish as recited in claim 1, the warming dish configured to rest atop the decorative base, the warming dish being removable from the decorative base.

15. The flameless warming device of claim 14, further comprising a second warming dish comprising a ceramic material, the second warming dish configured to rest atop the decorative base between the decorative base and the warming dish.

16. The flameless warming device of claim 14, further comprising a regulator in electronic communication with the heater, the regulator comprising a handle and a control knob for controlling the temperature of the heater.

17. A method of serving melted chocolate, comprising:
providing a warming dish a recited in claim 1;
heating a substantially enclosed opaque container carrying chocolate therein in a microwave oven until the chocolate is melted; and
pouring the melted chocolate from a spout and into the warming dish, the spout integrally formed on the opaque container.

18. A method of manufacturing a warming dish for use with a flameless warming device, the method comprising:
forming a main body including a base portion and side walls integral with and upwardly extending from the base portion and sizing and configuring the base portion to rest upon a base of a flameless warming device, the side walls and the base portion together defining an interior volume of the warming dish for containing a volume of liquid, the main body comprising a material exhibiting a relatively low thermal conductivity; and
providing a heat spreader comprising a material exhibiting a relatively high thermal conductivity in direct physical contact with the base portion of the main body such that thermal energy generated by a base of a flameless warming device is transmitted by the heat spreader to the base portion of the main body to regulate and moderate a temperature of the base portion during use.

19. The method of claim 18, wherein forming the main body comprises injection molding the main body at least partially around the heat spreader.

20. The method of claim 19, further comprising:
selecting the material of the main body to comprise silicone; and
selecting the material of the heat spreader to comprise metal.
